(19) United States
(12) Patent Application Publication
(10) Pub. No.: US 2016/0074776 A1
(43) Pub. Date: Mar. 17, 2016

(54) SYSTEM TO SELF-CLEAN AN IFS USING SUPERNATANT FROM ANOTHER CLARIFICATION TANK

(71) Applicant: ClearCove Systems, Inc., Rochester, NY (US)

(72) Inventor: Terry Wright, Rochester, NY (US)

(21) Appl. No.: 14/488,512

(22) Filed: Sep. 17, 2014

(51) Int. Cl. B01D 21/00; B01D 21/34

(52) U.S. Cl. CPC B01D 21/0006; B01D 21/0039; B01D 21/34; B01D 2021/0078

(57) ABSTRACT

A self-cleaning system for flushing an influent feed system (IFS) trough of a wastewater treatment facility by use of a supernatant includes one or more IFS disposed in a first clarification tank. Each IFS includes a grit box to capture waste materials and to convey the waste materials into a hopper of the IFS. The hopper has at least one IFS discharge pipe to convey the materials out of the hopper as controlled by an IFS valve. At least a second clarification tank also includes one or more IFS disposed in the second clarification tank. One or more pipes fluidly couple at least one trough of the one or more IFS of the first clarification tank to at least one trough of the one or more IFS of the second clarification tank. A supernatant flows through the one or more pipes. An IFS with a plow is also described.

### FIELD OF THE APPLICATION

The application relates to cleaning parts of a wastewater treatment system and particularly to a system to clean an influent feed system (IFS).

### BACKGROUND

Waste water treatment systems typically maintain a continuous flow of influent entering a clarification tank and effluent exiting the clarification tank for secondary treatment. The influent that resides above solids settled in the clarification and that is substantially free of suspended solids is called the supernatant.

### SUMMARY

According to one aspect, a self-cleaning system for flushing an influent feed system (IFS) trough of a waste water treatment facility by use of supernatant includes one or more IFS disposed in a first clarification tank. The one or more IFS are in fluid communication with an influent stream. Each IFS includes a grit box to capture dense waste materials and to convey the waste materials into a hopper of the IFS. The hopper has at least one IFS discharge pipe to convey the materials out of the hopper as controlled by an IFS valve. At least a second clarification tank also includes one or more IFS disposed in the second clarification tank. The one or more IFS are in fluid communication with the influent stream. Each IFS has substantially same structure as the one or more IFS disposed in the first clarification tank. One or more pipes fluidly couple at least one trough of the one or more IFS of the first clarification tank to at least one trough of the one or more IFS of the second clarification tank. A supernatant flows through the one or more pipes from a selected one of: the second clarification tank to the at least one trough of the IFS of the first clarification tank when a fluid level of the supernatant in the second clarification tank is higher than the fluid level of the supernatant in the first clarification tank, or the first clarification tank to the at least one trough of the IFS of the second clarification tank when the fluid level of the supernatant in the first clarification tank is higher than the fluid level of the supernatant in the second clarification tank.

In one embodiment, the self-cleaning system further includes one or more transfer pumps disposed in the one or more pipes to enhance the flow of the supernatant through the one or more pipes.

In another embodiment, the self-cleaning system further includes one or more transfer valves disposed in the one or more pipes to control a gravity induced flow or a pump induced flow of the supernatant through the one or more pipes.

In yet another embodiment, the self-cleaning system further includes a controller operatively coupled to the one or more transfer valves to automatically control the self-cleaning system.

In yet another embodiment, the self-cleaning system further includes a fluid level sensor disposed in the clarification tank and operatively coupled to the controller.

In yet another embodiment, the self-cleaning system further includes a flow meter sensor disposed in the one or more pipes and operatively coupled to the controller.

In yet another embodiment, the self-cleaning system further includes a UVAS or an organic content sensor disposed in the IFS discharge pipe and operatively coupled to the controller.

In yet another embodiment, the self-cleaning system further includes a turbidity sensor disposed in the IFS discharge pipe and operatively coupled to the controller.

In yet another embodiment, the self-cleaning system further includes a suspended solids sensor disposed in the IFS discharge pipe and operatively coupled to the controller.

In yet another embodiment, the controller includes a supervisory control and data acquisition system (SCADA) system.

In yet another embodiment, the self-cleaning system further includes one or more plows disposed in the trough of the one or more IFS.

In yet another embodiment, at least one of the one or more plows includes an angled plate.

In yet another embodiment, at least one of the one or more plows includes a pyramidal wedge mechanically coupled to the angled plate.

According to another aspect, an influent feed system (IFS) with a plow includes an IFS trough which is coupled to the IFS. The IFS trough has an IFS trough surface. A plate of the plow is disposed over the surface of the IFS trough and in fluid communication with a fluid pipe that supplies the fluid to the IFS trough. The plate enhances a flow of the fluid over the IFS trough and to distribute the fluid across the IFS trough to eliminate or reduce a channeling of the fluid by settled solids.

In one embodiment, the plate includes an angled plate.

In another embodiment, the plow further includes a pyramidal wedge mechanically coupled to the angled plate.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 shows a schematic diagram of an exemplary clarification system that selectively classifies and separates grits, solids, particulates and solvated materials from an influent stream;

FIG. 2A shows a block diagram of a current influent and flocculants mixing device system;

FIG. 2B shows a block diagram of another exemplary current influent and flocculants mixing device system;

FIG. 3 shows a block diagram of an exemplary influent feed system (IFS);

FIG. 4 shows a top view the IFS of FIG. 3;

FIG. 5 shows a block diagram of an exemplary embodiment of an IFS where fluid traversing IFS scouring pipes is used to scour the IFS troughs and grit box;

FIG. 6A shows and view of an exemplary IFS trough where the trough walls are not angled;

FIG. 6B shows and view of an exemplary IFS trough with angled trough walls;

FIG. 7 shows an top view of exemplary clarification tanks with IFS cleaning apparatus;

FIG. 8 shows a cross-sectional end view of two IFS of FIG. 7;

FIG. 9A shows a diagram of a side view of an exemplary plow;

FIG. 9B shows a diagram of a top view of the exemplary plow of FIG. 9A;

FIG. 10 shows another diagram of a top view of clarification settling tanks with IFS and IFS cleaning apparatus;

FIG. 11 shows a diagram of a side view of an exemplary IFS with an IFS trough; and

FIG. 12 shows a flow diagram of an exemplary method to self-clean an IFS trough of a wastewater treatment facility with flushing by a supernatant.

### DETAILED DESCRIPTION

Current waste water treatment primary clarification systems maintain a continuous flow of influent entering a clarification tank. Effluent exits the clarification tank for secondary treatment. Usually there is an incomplete removal solids and particulates and little if any separation of desirable materials from undesirable materials. As disclosed in U.S. Pat. No. 7,972,505, “Primary Equalization Settling Tank” (hereinafter the '505 patent), U.S. Pat. No. 8,225,942, “Self-Cleaning Influent Feed System for a Waste Water Treatment Plant” (hereinafter the '942 patent), U.S. Pat. No. 8,398,864, “Screened Decanter Assembly” (the 864 patent), and pending U.S. patent application Ser. No. 14/141,297, “Method and Apparatus for a Vertical Lift Decanter System in a Water Treatment Systems” (hereinafter the '297 application) and U.S. patent application Ser. No. 14/142,099, “Floatables and Scum Removal Apparatus for all purposes, Clear Cove Systems has developed systems and processes for primary clarification that remove all grit, solids and particulates larger than 50 microns during primary clarification. The above named applications and patents are incorporated herein by reference in their entirety for all purposes. Also, as described in co-pending application, U.S. patent application Ser. No. 14/325,421, “IFS and Grit Box for Water Clarification Systems” (hereinafter the '421 application), which is incorporated by reference in its entirety for all purposes, Clear Cove Systems typically includes an Influent Feed System (IFS) to provide for the classification and separation of grits, solids, particulates and solvated materials from an influent stream.

A new improved apparatus and method to clean an Influent Feed System (IFS) is now described in more detail. The IFS includes one or more grit boxes and one or more IFS troughs. The IFS is arranged into selected regions with predetermined influent rise velocities to classify solids. The selected regions are used for the classification of solids by their settling rates. Optionally, flocculants can be added to settle suspended and solvated materials. By use of flocculants, selected materials can be removed from the influent stream before it spills over the IFS Trough weir into a clarification tank where materials that are predominantly smaller than those settled in the IFS are separated from the influent stream.

Current waste water treatment systems often use flocculants to remove solids and solvated materials from the influent. However, one problem with current systems is that the devices used to provide adequate mixing of flocculants with the influent stream can cause an uncontrolled settling and depositing of the flocs in undesirable locations, resulting in variations in the flow rates and maintenance issues associated with removing the deposits.

Another problem with current systems is that during periods of high flow, or due to inadequate mixing, it can be necessary to incorporate a ballasted floc reactor as part of the water treatment plant. A ballasted floc reactor uses sand in addition to flocculants to enhance the deposition of solids and solvated materials from the influent stream. Sand is an undesirable additive as it creates expense and adds volume to the deposits. In addition, ballasted floc reactors can require maintenance as a consequence of waste water solids plugging the hydrocyclone that separates sand from solids and the sand fouling piping and inlets.

In one embodiment, the mixing of the flocculants and influent is controlled to cause deposition of the flocs in a predetermined portion of the IFS, without creating the maintenance issues described hereinabove. The influent entering the IFS first enters a grit box. The influent stream is split into two or more separate streams which are then recombined under pressure to create a turbulent mixing of the recombined streams with a flocculants. Flocculants are added to the influent prior to influent entering the IFS, in the IFS or in the grit box. The turbulent mixing promotes rapid action of the flocculants with the solids and/or solvated materials, reducing or eliminating the need for sand and results in the deposition of the flocs in a controlled portion of the clarification system. The grit box has a turbulence deflector, such as, for example, a curved or angular plate, to return upward velocities back into the main mixing zone.

The IFS is in fluid communication with a clarification tank such as, for example, the tank disclosed in the '421 application. Influent free of materials that settled in the IFS accumulates in the clarification tank where suspended solids settle to form a layer of sludge on the bottom of the clarification tank. Under the influence of gravity there is a gradient in the concentration of suspended materials in the influent with fluid in the upper portion of the clarification tank being substantially free of suspended materials (the supernatant) while fluid at the bottom of the clarification tank has a higher concentration of suspended materials.

The IFS can be cleaned and scoured by flushing with the supernatant, efficiently removing the settled solids, which are typically lighter flocculated materials, in the IFS. This cleaning technique, in combination with the design of the IFS and associated grit box, results in the simplified removal of settled flocs without incurring maintenance issues associated with other prior art designs. The method and apparatus of providing the IFS scouring liquid can be operated under the force of gravity, thus using little energy.

In some embodiments the apparatus includes a plow to distribute the influent across the bottom of the IFS troughs to eliminate or reduce channeling of the fluid in the settled solids.

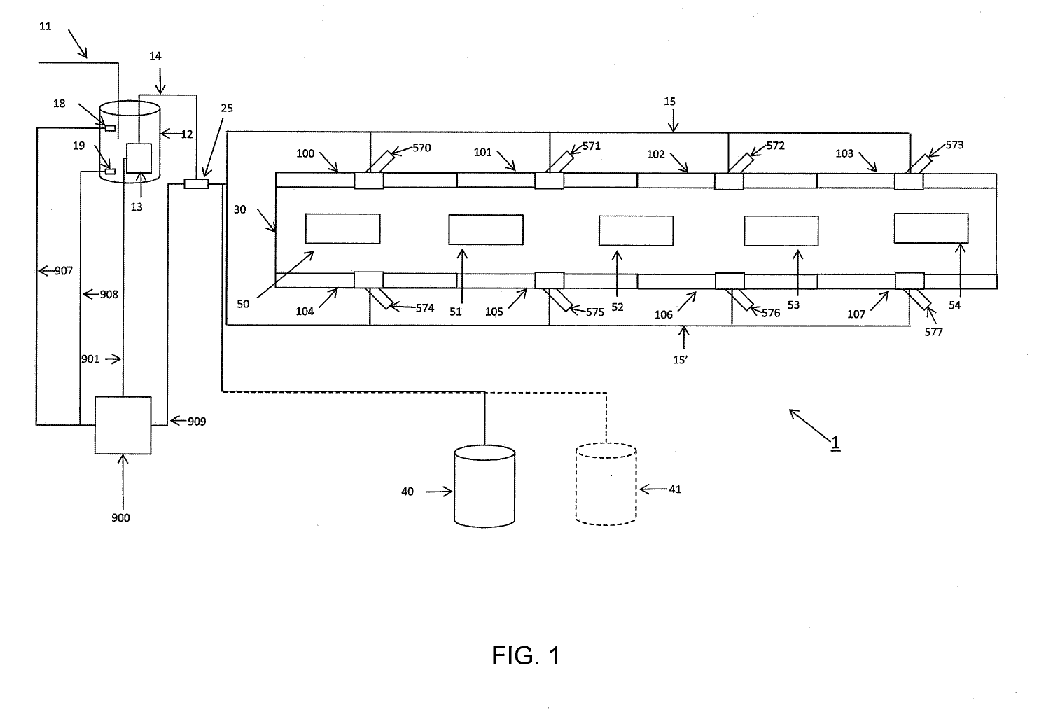

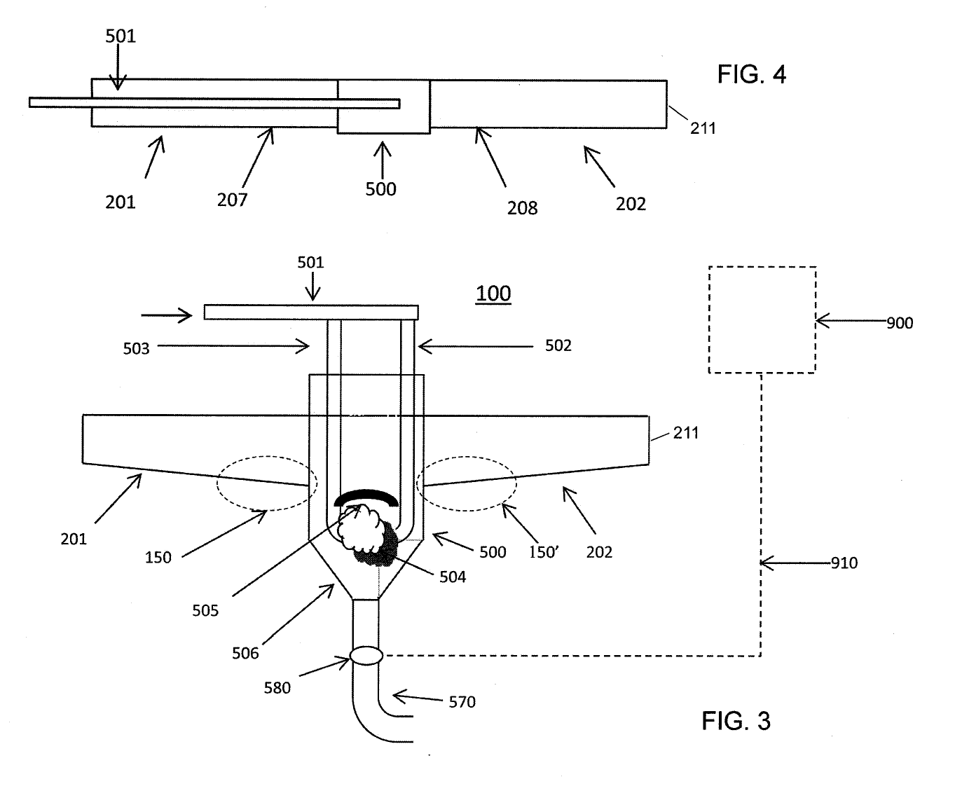

FIG. 1 shows a block diagram of an exemplary clarification system 1 configured to selectively classify and separate grits, solids, particulates and solvated materials from an influent stream. The Influent enters the clarification system 1 via pipes 11 where it is stored in wet well 12. In the exemplary embodiment of FIG. 1, settling tank 30 is in fluid communication with 8 IFS (IFS 100 107). Each of the IFS 100-107 can be configured substantially identically, including, for example, two IFS troughs, a grit box and a discharge pipe as shown in more detail in FIG. 3.

Continuing with the exemplary embodiment of FIG. 1, pump 13 pumps influent from the wet well 12 to IFS 100-107 at a substantially constant flow rate via piping 14, 15 and 15′. Pump 13 can be operated by manual control, or by any suitable automatic controls, such as, for example, under the control of a supervisory control and data acquisition system (SCADA) 900 in communication with pump 13 via communication channel 901. In an exemplary SCADA control system, SCADA 900 turns pump 13 on in response to an indication of the wet well 12 fluid level reaching an upper limit. The upper limit indication can be provided, for example, by a sensor 18 in communication with SCADA 900 via communication channel 907. SCADA 900 can turn pump 13 off in response to an indication of the wet well 12 fluid level reaching a lower limit. In the exemplary system of FIG. 1, the lower limit indication is provided by sensor 19 in communication with SCADA 900 via communication channel 908. In alternative embodiments, SCADA 900 can turn pump 13 off after a pre-determined period of time. In some embodiments, SCADA 900 can turn pump 13 off after a predetermine volume of fluid has been pumped as indicated by measuring the flow via signals provided by flow meter 25 in communication with SCADA 900 via communication channel 909. Flow meters and sensors to measure fluid level are well known in the art.

As is well known in the art, piping 14, 15 and 15′ can be configured to deliver substantially the same flow rate of influent to each IFS 100-107. Flow balancing valves and/or flow splitting can be used. Optionally, flocculants are added by one or more flocculent delivery systems 40, 41 to the influent stream prior to its delivery to the IFS 100-107. The use of flocculants, for the removal of solids and solvated materials in the treatment of waste water and designs to add flocculants to an influent waste water stream are well known in the art. The influent enters the IFS 100-107 where grits, solids, and optionally solvated materials, are selectively classified and separated from the influent via settling and optionally flocculation or precipitation. Materials settled in IFS 100-107 are removed via discharge pipes 570-577. The influent traverses IFS 100-107 to enter the clarification tank 30. As described in the, '505 patent, '864 patent, '297 application and '421 application, solids remaining in the influent traversing to the clarification tank 30 are further classified and separated from the influent via settling. Upon completion of the separation of the solids from the influent, the influent is discharged from the settling tank 30 such as by use of screen box assemblies (SBX) 50-54 as described in the '297 application.

As described hereinabove, flocculants can be optionally added to the influent stream by flocculent delivery systems 40, 41 (FIG. 1). The use of flocculants, for the removal of solids and solvated materials in the treatment of waste water and designs to add flocculants to an influent waste water stream are well known in the art. Flocculants are most effective when they are adequately mixed with the influent.

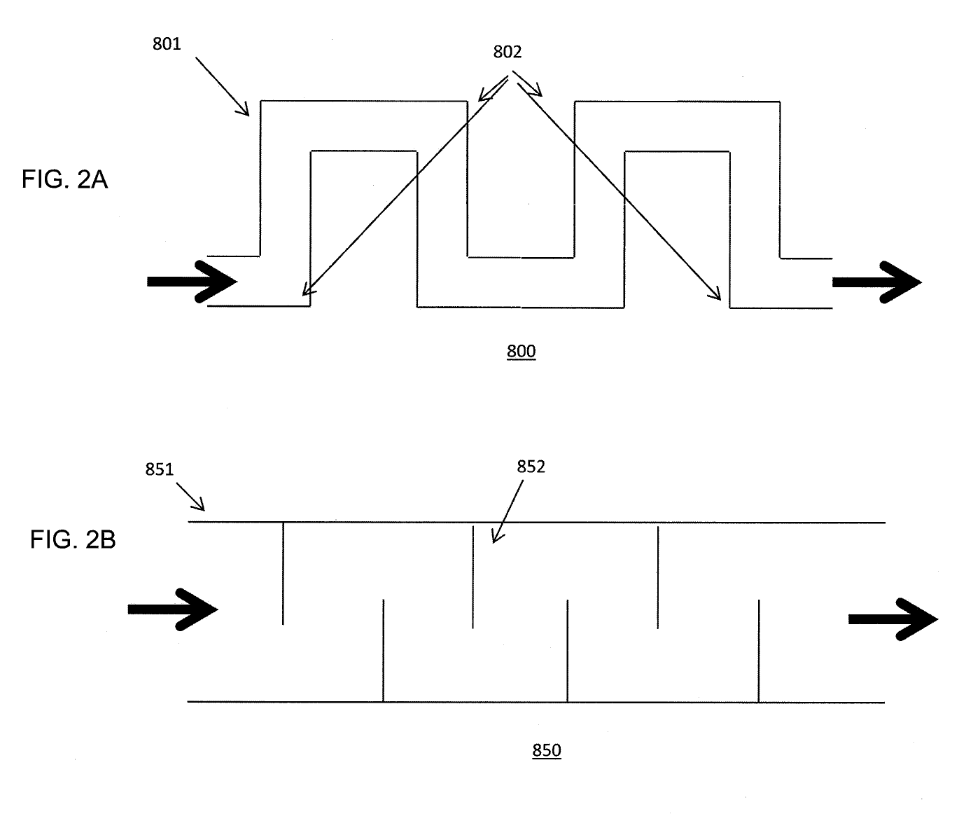

Current systems use a variety of techniques to mix flocculants with influent streams. One problem with current systems is that the devices used to provide adequate mixing of flocculants with the influent stream can readily foul as rags and large solids can plug the small passage ways that induce turbulence or wrap around mixers resulting in excess chemical use and/or interrupted flow during maintenance of the static or dynamic mixers. Examples of current systems with these short comings are provided in FIG. 2A and FIG. 2B.

FIG. 2A shows a block diagram of a current influent and flocculant mixing device system 800. FIG. 2B shows a block diagram of another exemplary current influent and flocculant mixing device system 850. Current influent and flocculant mixing device systems 800 and 850 rely upon creating zones of turbulence 802 and 852 respectively to mix the flocculant and influent in the piping 801, 851 used to transport the influent and flocculant through the clarification system to the region where sedimentation is desired. Over time, settling of flocs in regions 802, 852 can impede influent flow resulting in the need to perform maintenance.

FIG. 3 shows a block diagram of an exemplary IFS. FIG. 4 shows a top view the IFS of FIG. 3. A mixing zone can be created within a grit box 500 at the location where deposition of the floc is desired. IFS 100 is configured with a grit box 500 and two IFS troughs 201, 202 in fluid communication with the grit box 500. Influent is delivered to the IFS 100 via pipe 501 and split into two streams which enter the grit box 500 via pipes 502, 503. The streams exit opposing pipes 502, 503 and collide under pressure to create a turbulent mixing zone 504. A deflector plate 505 is shown positioned above the mixing zone 504 to confine the volume of the mixing zone and return the upward velocities of the streams existing pipes 502, 503 back into the Mixing Zone 504. The deflection plate 505 can also be a curved or angular plate to keep sludge from settling on top of the deflection plate 505. Grit, dense solids and flocs are deposited in the grit box hopper 506. A further benefit of the new apparatus to clean IFS using supernatant from a clarification tank is that the materials in the grit box 500 can be removed as part of the routine operation of the clarification system by the scouring of the IFS.

Continuing with FIG. 3, to limit disturbance of solids settling in the lower portion 150, 150′ of the IFS Troughs 201, 202 in proximity to the grit box 500, the length of the pipes 502, 503 can be arranged to position the mixing zone 504 below the lowest portion 150, 150′ of the IFS troughs 201, 202 in proximity to and in fluid communication with the grit box 500. Positioning the mixing zone 504 and grit box hopper 506 below the lowest portion 150, 150′ of the IFS troughs 201, 202 in proximity to and in fluid communication with the grit box 500 results in only those solids with a lower settling rate than the designed influent rise velocity in the grit box hopper 506 from moving into the IFS troughs 201, 202. Additionally, prior to entering the IFS troughs 201, 202 the solids moving upward under the influence of the rising influent must undergo a 90 degree change in direction, turning from vertical to horizontal thus losing inertia and lessening the fluid forces on the suspended grits, solids and flocs.

Example: In one exemplary embodiment of an IFS of the type of FIG. 3, the IFS is designed to separate particulate matter with a 100 mesh size or larger from the influent. The influent is pumped to the grit box 500 via pipe 501 at a constant flow rate of 280 GPM. Pipe 501 is 6 inches in diameter resulting in an influent velocity of 3.18 FPS. The flow is split between pipes 502, 503 each of which are 4 inches in diameter, resulting in an influent velocity of 3.57 FPS. The upper portion of grit box 500 above the grit hopper 506 has dimensions of 4′ in the direction parallel to the longest length of the IFS and 2.25′ in the direction perpendicular to the longest length of the IFS, resulting in a total surface area of 9 square feet. The resultant influent rise rate in the upper portion of the grit box 500 is 0.1388 feet per second (FPS), resulting in the settling of gel net, grits and solids with settling rates faster than 0.1388 FPS settling predominantly in the grit hopper 506. Typically, 50 mesh particles have a settling rate of 0.160 feet per second. The IFS Troughs, 201, 202 are sized to have an influent rise rate substantially less than the grit box 500 influent rise rate. In one embodiment each IFS troughs 201, 202 has a dimension of 10.5′ in the direction parallel to the longest dimension of the IFS and a dimension of 1′ in the direction perpendicular to the longest dimension of the IFS. The resultant influent rise rate in the IFS troughs 201, 202 is 0.0187 feet per second at the bottom of the IFS Troughs. Typically, 100 mesh particles have a settling rate of 0.042 feet per second.

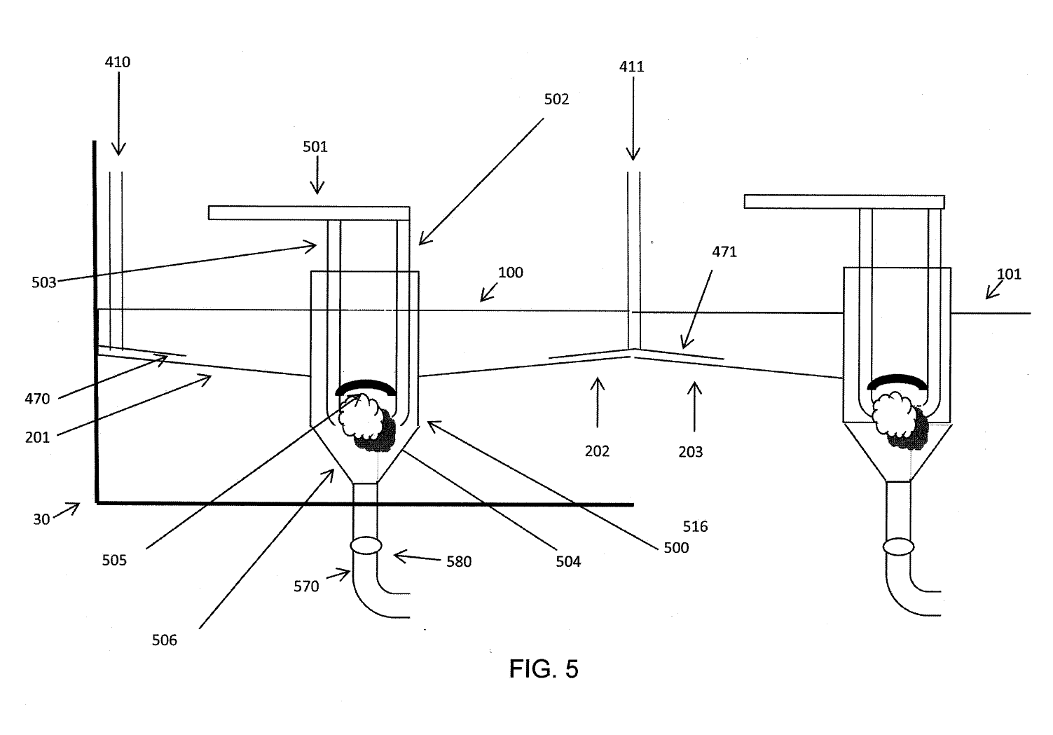

Turning now to FIG. 5, in some embodiments fluid is pumped through pipes 410, 411 to scour the IFS troughs and grit box. The materials settled in the grit box 500 can be removed via discharge pipe 570 in liquid communication with the IFS 100. Fluid communication via discharge pipe 570 can be controlled by valve 580. Valve 580 can be a manually operated valve. Or, valve 580 can be electronically controlled, such as, for example, by a supervisory control and data acquisition system SCADA 900 (FIG. 3) which provides a signal via communication channel 910 to open and close the valve 580. SCADA systems and electronically controlled valves are well known in the art. Materials settled in grit box 500 can have viscosity low enough to flow from the grit box under the influence of gravity.

When the IFS is full of influent, valve 580 can be opened to remove the settled materials. The head pressure from the influent and liquid above assists in moving the settled solids from the grit box 500 through the discharge pipe 570. Alternatively, valve 580 can be opened and IFS troughs 201, 202 can be scoured with liquid to evacuate solids from the entirety of the IFS 100.

Now, referring back to FIG. 1, in some embodiments of the new apparatus to clean IFS using supernatant from a clarification tank the influent stream is pumped at an overall flow rate sufficient to accommodate the maximum projected throughput the plant must handle, such as during a flood or severe rainstorm. For example, in a municipal waste water treatment plant the velocity of the influent in pipes 14, 15, 15′, 501, 502, 503 should be fast to avoid plugging the influent pipes with solids, but not so fast as to scour and wear pipes and pipe elbows. Typical influent flow velocities are in the range of 3 to 8 feet per second (FPS). The diameter of the pipes 501, 502, 503 (FIG. 3, FIG. 4, FIG. 5) is typically selected to avoid plugging with gross solids and provide a high velocity to create good mixing of the streams in the mixing zone 504.

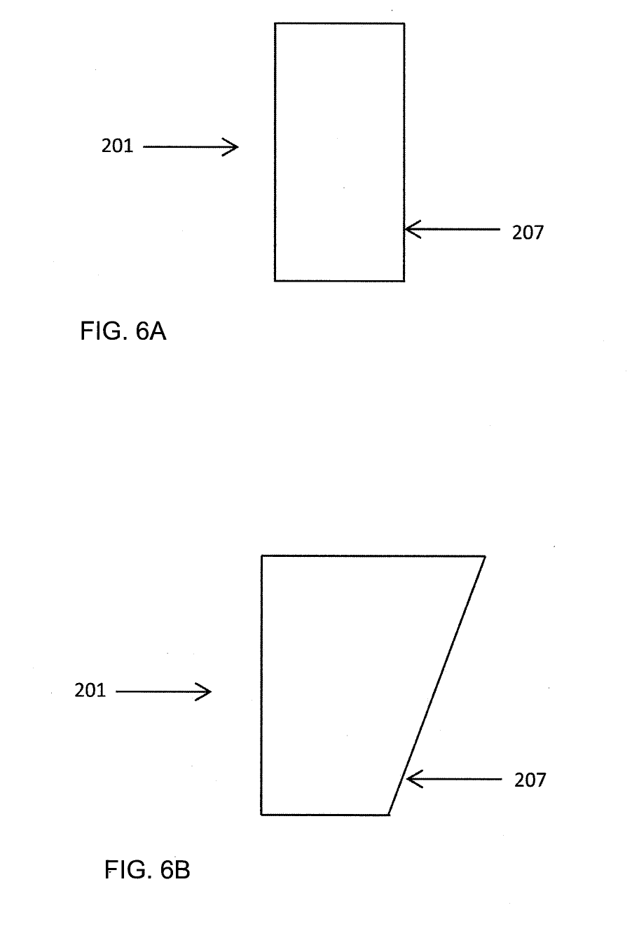

In some embodiments, as shown with reference to FIG. 6A, the IFS trough wall is not angled with respect to vertical. FIG. 6B shows and view of an exemplary IFS trough with angled trough walls. The influent rise rate in the IFS trough of the example hereinabove would be further decreased as the influent rises by angling the IFS trough walls 207 away from the vertical as shown with reference to FIG. 6B. In some embodiments, the IFS can be separated from the clarification tank by a solid wall that acts as a weir as described in '942 patent. With reference to FIG. 1 and the '942 patent (e.g. col. 5, lines 26-28), the influent flow rises in each fed IFT (Influent Feed Trough) 46 until it spills uniformly across the length of the smooth rounded weir 48 of the IFT 46. In other embodiments, now turning to FIG. 6B, the IFS trough wall 207 can be angled at 20 degrees from the vertical.

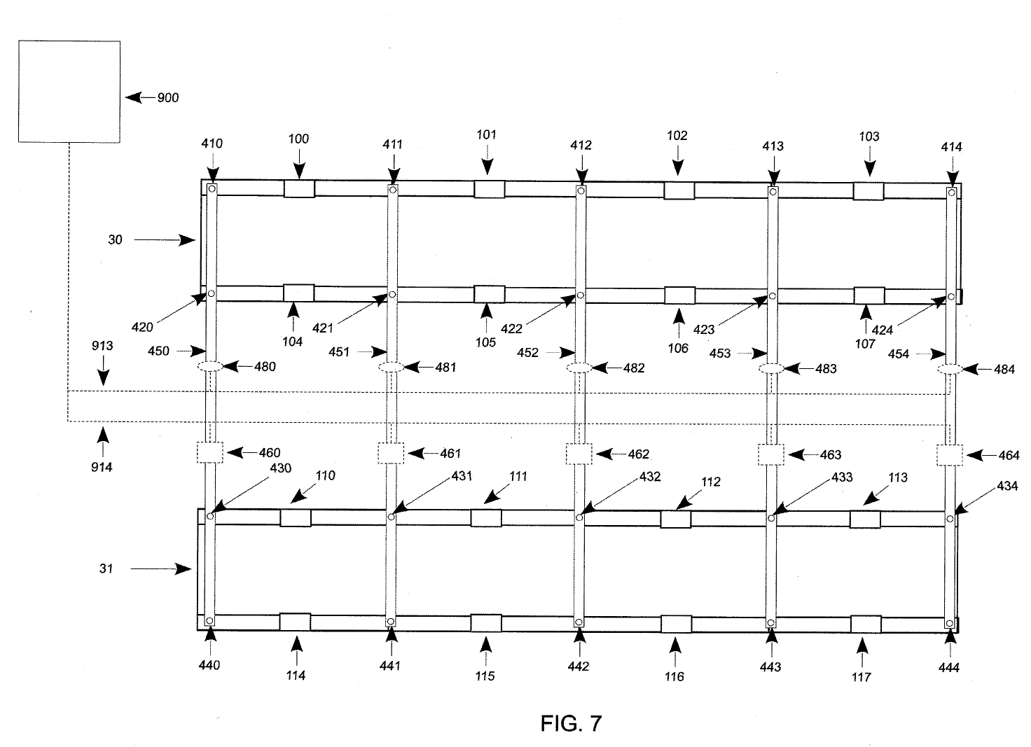

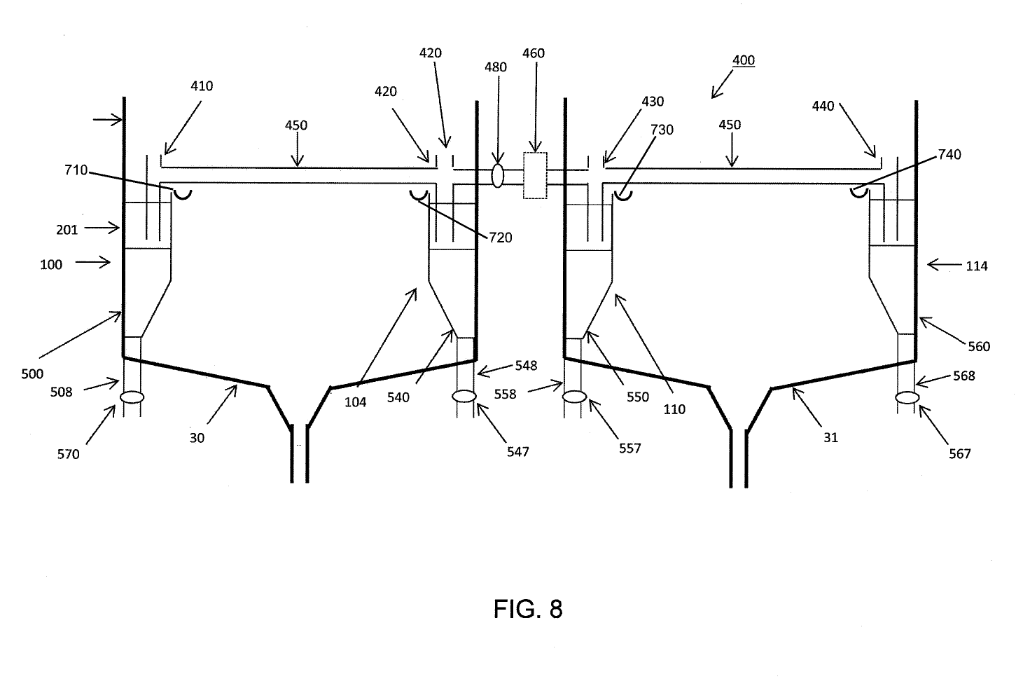

FIG. 7 shows a diagram of a top view of an exemplary plurality of clarification tanks with IFS cleaning apparatus. FIG. 8 shows an end view of four IFS 100, 104, 110, and 114 of FIG. 7. In the exemplary embodiment of FIG. 8, clarification tank 30 is proximate to clarification tank 31. Clarification tanks 30 and 31 are configured with SBX (not shown).

As shown in FIG. 7, Clarification tank 31 is configured with IFS associated with clarification tank 30. IFS 100 and IFS 104 for clarification tank 30 are in fluid communication with clarification tank 31 via pipes 450, 451. In some embodiments, fluid communication between IFS 100 and IFS 104, and clarification tank 30 is controlled by the opening and closing of optional valves 480, 481. Similarly, IFS 110 and IFS 114 for clarification tank 31 are in fluid communication with clarification tank 30 via pipes, 450, 451. In some embodiments, valves 480, 481 are manually operated valves. In alternate embodiments, valves 480, 481 can be under the control of and in communication with SCADA 900 via communication channel 910.

Cleaning IFS with supernatant: As described in the '993 application, '864 patent and '205 patent, particulates and solids settle in the clarification tank, resulting in the upper layer of the influent forming a supernatant this is substantially free of suspended solids and particulate matter. As described in more detail hereinbelow, the supernatant can be used to clean IFS. One or more IFS can be cleaned using supernatant from another clarification other than the clarification within which the IFS is located. Each IFS can be cleaned by supernatant supplied by one or more pipes directly to that IFS. IFS can also be cleaned by supernatant that flows from one IFS into another IFS where two or more IFS are fluidly coupled together, such as where a wall between two adjacent IFS is removed, also as is described in more detail hereinbelow.

Example of IFS trough cleaning structure: The IFS scouring pipes 410 and 420 are in fluid communication with pipe 450 and clarification tank 30 of FIG. 7. IFS scouring pipe 410 is also in fluid communication with IFS 100, and IFS scouring pipe 420 is in fluid communication with IFS 104. IFS scouring pipes 410, 420 are arranged to receive water from the clarification tank 31 when the fluid level in clarification tank 31 is higher than the uppermost portion of the IFS scouring pipes 430, 440. Supernatant entering the IFS scouring pipes 430, 440 traverses pipe 450 and is discharged via pipes 410, 420. As shown in more detail in FIG. 8, pipe 410 is arranged to discharge fluid from its lowermost portion at one end of IFS 100. Similarly, and with reference to FIG. 5, IFS scouring pipe 420 is arranged to discharge fluid from its lowermost portion at one end of IFS 104. A flow balancing valve, not shown, may be used balance the flow of liquid between pipes 410, 420. Flow balancing valves are well known in the art. Similarly, IFS scouring pipes 430 and 440 are in fluid communication with pipe 450 and clarification tank 31. IFS scouring pipe 430 is also in fluid communication with IFS 110, and IFS scouring pipe 440 is in fluid communication with IFS 114. IFS scouring pipes 430, 440 are arranged to receive water from the clarification tank 30 when the fluid level in clarification tank 30 is higher than the uppermost portion of the IFS scouring pipes 410, 420. Supernatant entering the IFS scouring pipes 410, 420 traverses pipe 450 and is discharged via pipes 430, 440. IFS scouring pipe 430 is arranged to discharge fluid from its lowermost portion at one end of IFS 110. IFS scouring pipe 440 is arranged to discharge fluid from its lowermost portion at one end of IFS 114.

Two or more IFS in fluid communication with each other: In some embodiments, the IFS 100-107 of clarification tank 30 (FIG. 7) are in fluid communication with IFS 110-117 of clarification tank 31. Also, by removing an end wall of each of the IFS, such as end wall 211 of IFS 100 as shown in FIG. 3, the IFS 100-103 can be arranged to be in fluid communication with one another. Similarly IFS 104-107 are in fluid communication with one another as are IFS 110-113 and IFS 114-117. Fluid communication between the IFS's associated with clarification tank 30 and clarification tank 31 is controlled by valves 480-484, with fluid traversing pipes 450-454. Similarly, clarification tank 31 is in fluid communication with IFS 110-117, each IFS 110-117, in fluid communication with clarification tank 30. Fluid communication between the IFS's is controlled by valves 480-484. Valves 480-484 can be manually operated valves. In other embodiments valves 480-484 can be more conveniently under the control of and in communication with SCADA 900 via communication channel 913. As is well known in the art, the SCADA can be configured to individually control valves 480-484, or they can be controlled as a single entity.

Example of IFS trough cleaning process: IFS 100-107 of clarification tank 30 are cleaned using fluid from another clarification tank 31. Clarification tank 31 is filled with influent with the upper level of the influent being higher than the upper most portions of IFS scouring pipes 430-437, 440-447. Clarification tank 30 and IFS 100-107 are substantially free of fluids, with settled material on the lowermost portion of the IFS troughs and grit boxes of IFS 100-107. As shown with reference to FIG. 3 and IFS 100, each IFS 100-107 has a drainage pipe in fluid communication with the incorporated grit box. Turning to FIG. 5, for example, IFS 100 has drainage pipe 570 in fluid communication with grit box 500. Fluid is drained from IFS 100 by opening valve 580, permitting fluid to drain under the influence of gravity and preferably with the assistance of a sludge pump (not shown).

Prior to initiating an IFS cleaning cycle, scum and floatables can be removed from the surface of the fluid residing in the tank as described in more detail in the '099 application. As shown with reference to FIG. 8, preferably the intake for pipes 410, 420, 430, 440 are above the scum and floatables removal apparatus 710, 720, 730, 740.

According to the exemplary method to clean IFS 100-107 (FIG. 7), the IFS discharge valves of IFS 100-107 are opened, and valves 480-484 controlling fluid communication between clarification tank 31 and IFS's 100-107 are opened. The supernatant from clarification tank 31 flows through pipes, 450-454, where it exits the lower most portion of the pipes, 410-414, 420-424 to flow down the IFS troughs IFS 100-107 and into the grit boxes, where it is drained via the associated drainage pipes. The velocity of the supernatant discharged into the IFS 100-107 is typically maintained at about 1 to 3 feet per second to ensure the materials deposited in the IFS are scoured and removed.

Now referring back to FIG. 5, in some embodiments of the system of FIG. 7, to prevent channeling of the supernatant discharged from IFS, scouring pipes 410, 411, plows, 470, 471 can be positioned in IFS troughs 201, 202 to spread the discharged supernatant across the width of the IFS troughs 201, 202 with more liquid going to the corners to scour the materials that build up in the corners due to the higher friction in the region where the horizontal and vertical surfaces of the IFS trough meet.

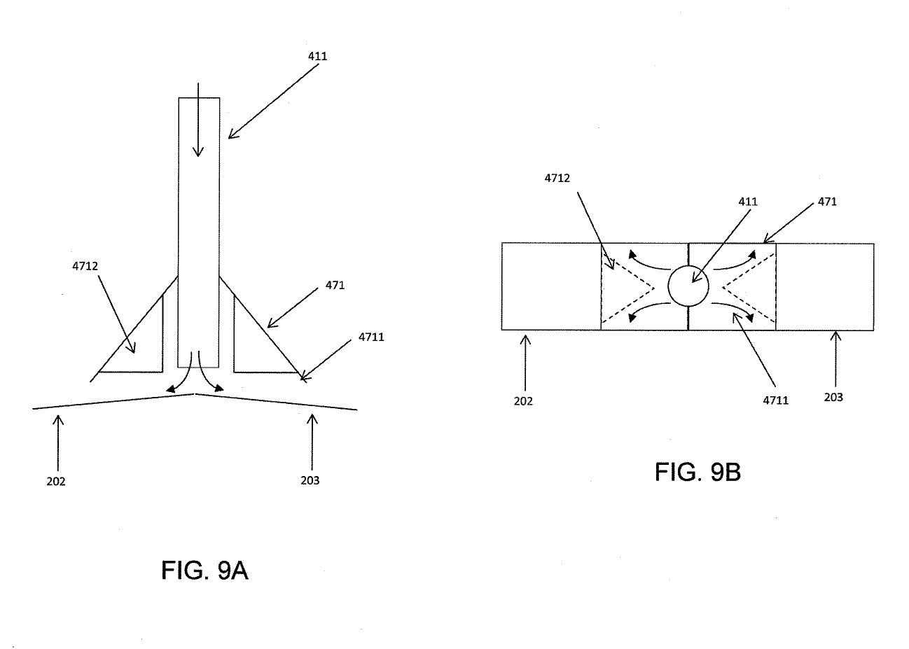

FIG. 9A and FIG. 9B show another exemplary embodiment of a plow to distribute the influent across the bottom of the IFS troughs eliminates or reduces channeling of the fluid in the settled solids. FIG. 9A shows a diagram of a side view of the exemplary plow. FIG. 9B shows a diagram of a top view of the plow of FIG. 9A. Plow 471 has a downward angled plate 4711 extending across the width of IFS troughs 202, 203 and positioned to within one to two inches from the bottom of IFS troughs 202, 203 at its lowest point. A pyramidal wedge 4712, affixed to angled plate 4711 enhances the flow of scouring fluid flowing from pipe 411 to increase the flow of scouring fluid to the region where the vertical and horizontal surfaces of IFS troughs 201, 202 meet and materials deposits are largest.

In alternative embodiments, with reference to FIG. 7, optional transfer pumps 460-464 can be placed in line with pipes 460-464 to further increase the velocity of the supernatant and improve scouring of the IFS 100-107. In some embodiments, the transfer pumps 460-464 are reversible pumps, such as progressing cavity pumps, able to pump fluid in either direction. In some embodiments transfer pumps 460-464 are manually controlled. Transfer Pumps 460-464 can also be under the control of and in communication with SCADA 900 via communication channel 915. As is well known in the art, the SCADA can be configured to individually control transfer pumps 460-464, or they can be controlled as a single entity.

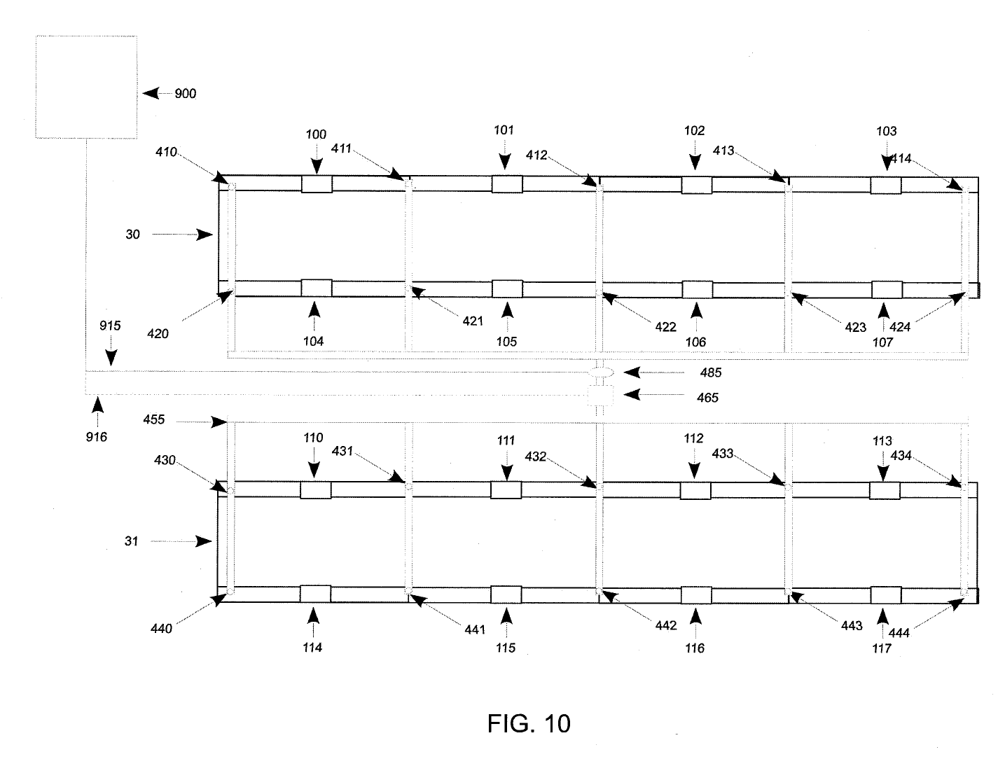

Turning to FIG. 10, in other embodiments, IFS scouring pipes 410-414, 420-424 are in fluid communication with pipes 455 and clarification tank 31. Similarly, pipes 430-434, 440-444 are in fluid communication with pipes 455 and clarification tank 30. The flow of fluid is controlled by valve 485 and optional, optionally reversible transfer pump 465. To ensure proper flow rates through pipes 410-414, 420-424, 430-434, 440-444, flow balancing valves and/or flow splitting can be used, as is well known in the art. Valve 485 and transfer pump 465 can be manually controlled. Or, in a computer controlled configuration, such as, for example, under SCADA control, valve 485 can be controlled by and in communication with SCADA 900 via communication channel 915, transfer pump 465 can be controlled by and in communication with SCADA 900 via communication channel 916, and pump 485 can also be controlled by and in communication with SCADA 900 via communication channel 915.

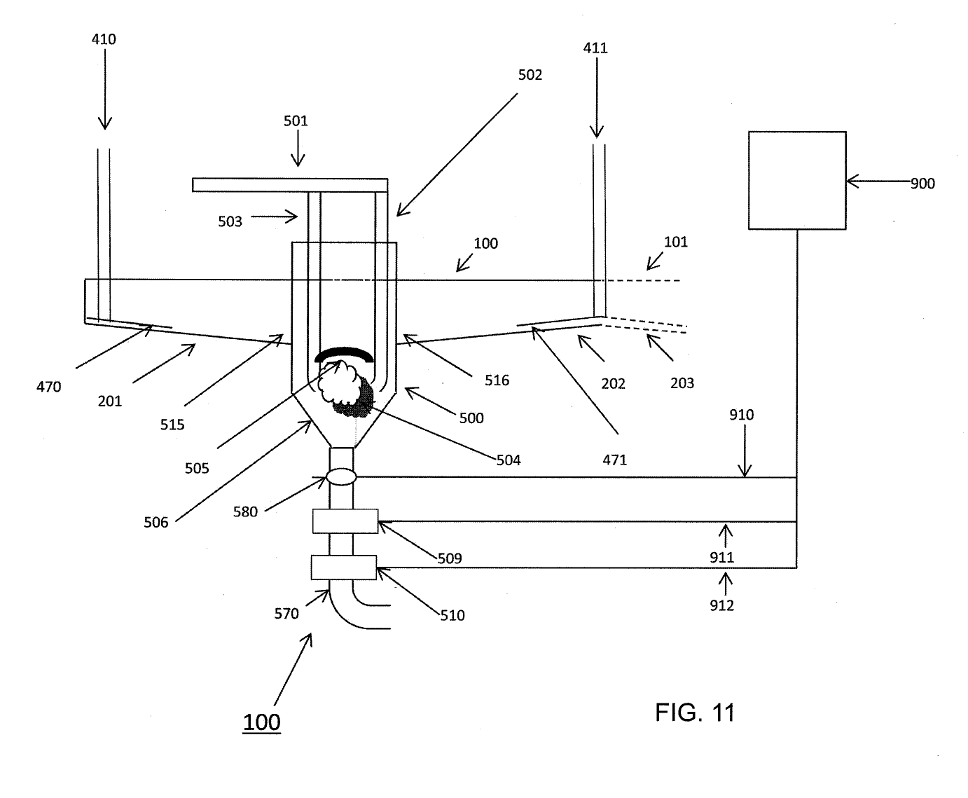

In one embodiment, with reference to FIG. 11, IFS 100 drainage pipe 570 is configured with a flow meter 509. Flow meter 509 is in communication with SCADA 900. In one embodiment SCADA 900 closes control valve after a pre-determined amount of fluid has passed through the drainage pipe as measured by flow meter 509. In one embodiment, and with reference to FIG. 11, flow meters are configured on the drainage pipes of IFS 100-107 and control valves 480-484 are separately controlled based upon the signals from the corresponding flow meters.

FIG. 11 shows a diagram of a side view of an exemplary IFS with an IFS trough, grit box, and sensor on a drainage pipe. IFS 100 drainage pipe 570 is configured with a sensor 510 in communication with SCADA 900 via communication channel 912 to measure the amount of solids being flushed from the IFS 100. The sensor 510 can be a UV sensor (e.g. an Ultraviolet Light Absorbance/Transmittance Sensor (UVAS)), a turbidity sensor, and organic content sensor, or any other suitable solids sensor. SCADA 900 closes control valve 580 when signals from sensor 510 indicate the fluid passing through the drainage pipe 570 is substantially free of settled materials.

In some embodiments, such as those illustrated in FIG. 1, FIG. 10, and FIG. 11, sensors (not shown) substantially similar to sensor 510 can be configured on the drainage pipes 570-577 (e.g. FIG.1) of IFS 100-107 and in communication with SCADA 900 via one or more communication channels (not shown) substantially similar to communication channel 912 and SCADA 900 closes control valves 480-484 in response to signals from the sensors indicating the fluid passing through discharge pipes 570-577 is substantially free of settled materials. Turning to FIG. 7, in some embodiments, SCADA 900 closes, for example, control valve 480 after a pre-determined period of time. In one embodiment the control valve 480 is closed after the supernatant in clarification tank 31 falls below the upper most portions of pipes 430, 440 resulting in no more flow of supernatant through pipe 450 and IFS 100, 104. The cessation of flow through the IFS 100 can be detected by flow meter 509 (FIG. 11) in communication with SCADA 900.

Turning back to FIG. 11, after completion of an IFS cleaning cycle, IFS discharge pipe control valve 580 is closed. Similarly, in a system with multiple IFS as disclosed with respect to FIG. 1, upon the completion of the IFS cleaning cycle, the discharge pipe control valves (not shown) for discharge pipes 570-577 (FIG. 7) are closed. An IFS 100 can be cleaned after a pre-determined number of cycles of filling and emptying clarification tank 30 in accordance with the operation of the clarification system to separate solids from the influent. In some embodiments, during or after IFS 100 is emptied to remove settled materials, when there is an indication (e.g. from sensor 509) of the presence of solids above a predetermined threshold in fluid traversing discharge pipe 570 the IFS 100 is cleaned such as by use of one of the IFS cleaning techniques described hereinabove.

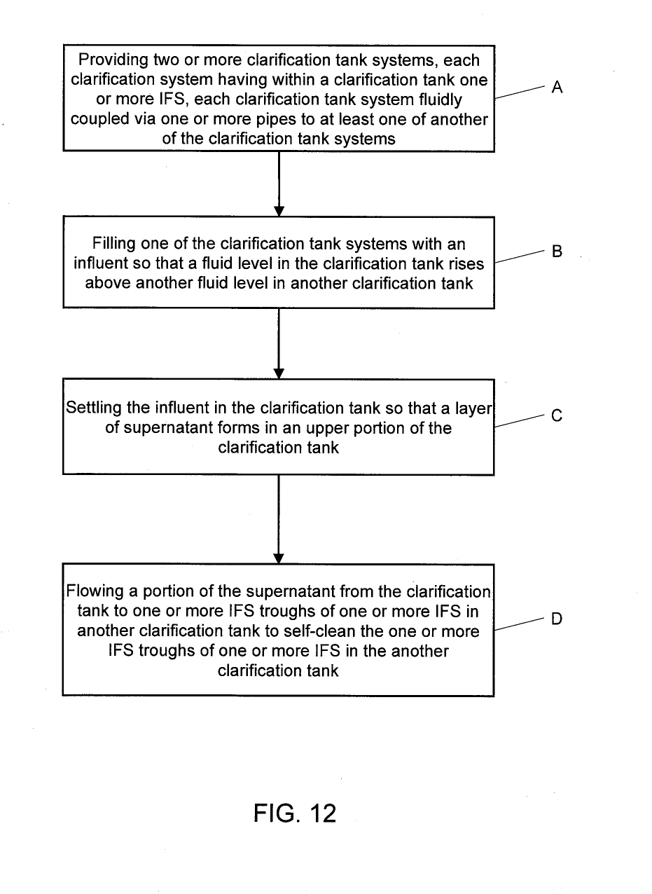

FIG. 12 shows a flow diagram of an exemplary method to self-clean an influent feed system (IFS) trough of a wastewater treatment facility with flushing by a supernatant including the steps of: A) providing two or more clarification tank systems, each clarification system having disposed within a clarification tank one or more IFS, each clarification tank system fluidly coupled via one or more pipes to at least one of another of the clarification tank systems; B) filling one of the clarification tank systems with an influent so that a fluid level in the clarification tank rises above another fluid level in another clarification tank; C) settling the influent in the clarification tank so that a layer of supernatant forms in an upper portion of the clarification tank; and D) flowing a portion of the supernatant from the clarification tank to one or more IFS troughs of one or more IFS in another clarification tank to self-clean the one or more IFS troughs of one or more IFS in the another clarification tank.

Program code to control an apparatus to clean IFS using supernatant from a clarification tank as described hereinabove can be provided on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

It will be understood by those skilled in the art that any suitable controller, such as, for example, any suitable computer processor based controller can be used in place of the exemplary SCADA controller of the examples described hereinabove. Such controllers are understood to include any suitable computer, desktop, laptop, notebook, workstation, tablet, etc. Such controllers are also understood to include any suitable embedded computer including one or more processors, microcontrollers, microcomputers, and/or logic having firmware or software that can perform the functions of a computer processor.

It will be appreciated that variants of the above-disclosed and other features and functions, or alternatives thereof, can be combined into many other different systems or applications. Various presently unforeseen or unanticipated alternatives, modifications, variations, or improvements therein can be subsequently made by those skilled in the art which are also intended to be encompassed by the following claims.

What is claimed is:

1. A self-cleaning system for flushing an influent feed system (IFS) trough of a wastewater treatment facility by use of a supernatant comprising:
one or more IFS disposed in a first clarification tank, said one or more IFS in fluid communication with an influent stream, each IFS comprising a grit box to capture waste materials and to convey said waste materials into a hopper of said IFS, said hopper having at least one IFS discharge pipe to convey said materials out of said hopper as controlled by an IFS valve;
at least a second clarification tank also comprising one or more IFS disposed in said second clarification tank, said one or more IFS in fluid communication with said influent stream, each IFS comprising a substantially same structure as said one or more IFS disposed in said first clarification tank;
one or more pipes fluidly coupling at least one trough of said one or more IFS of said first clarification tank to at least one trough of said one or more IFS of said second clarification tank; and
wherein a supernatant flows through said one or more pipes from a selected one of:
said second clarification tank to said at least one trough of said IFS of said first clarification tank when a fluid level of said supernatant in said second clarification tank is higher than said fluid level of said supernatant in said first clarification tank, or
said first clarification tank to said at least one trough of said IFS of said second clarification tank when said fluid level of said supernatant in said first clarification tank is higher than said fluid level of said supernatant in said second clarification tank.

2. The self-cleaning system of claim 1, further comprising one or more transfer pumps disposed in said one or more pipes to enhance said flow of said supernatant through said one or more pipes.

3. The self-cleaning system of claim 1, further comprising one or more transfer valves disposed in said one or more pipes to control a gravity induced flow or a pump induced flow of said supernatant through said one or more pipes.

4. The self-cleaning system of claim 3, further comprising a controller operatively coupled to said one or more transfer valves to automatically control said self-cleaning system.

5. The self-cleaning system of claim 4, further comprising a fluid level sensor disposed in said clarification tank and operatively coupled to said controller.

6. The self-cleaning system of claim 4, further comprising a flow meter sensor disposed in said one or more pipes and operatively coupled to said controller.

7. The self-cleaning system of claim 4, further comprising a UVAS or an organic content sensor disposed in said IFS discharge pipe and operatively coupled to said controller.

8. The self-cleaning system of claim 4, further comprising a turbidity sensor disposed in said IFS discharge pipe and operatively coupled to said controller.

9. The self-cleaning system of claim 4, further comprising a suspended solids sensor disposed in said IFS discharge pipe and operatively coupled to said controller.

10. The self-cleaning system of claim 4, wherein said controller comprises a supervisory control and data acquisition system (SCADA) system.

11. The self-cleaning system of claim 1, further comprising one or more plows disposed in said trough of said one or more IFS.

12. The self-cleaning system of claim 11, wherein at least one of said one or more plows comprises an angled plate.

13. The self-cleaning system of claim 12, wherein at least one of said one or more plows comprises a pyramidal wedge mechanically coupled to said angled plate.

14. An influent feed system (IFS) with a plow comprising:
an IFS trough coupled to said IFS, said IFS trough having an IFS trough surface; and
a plate of said plow disposed over said surface of said IFS trough and in fluid communication with a fluid pipe that supplies said fluid to said IFS trough, said plate to enhance a flow of said fluid over said IFS trough and to distribute said fluid across said IFS trough to eliminate or reduce a channeling of said fluid by settled solids.

15. The IFS trough with said plow of claim 14, wherein said plate comprises an angled plate.

16. The IFS trough with said plow of claim 15, wherein said plow further, comprises a pyramidal wedge mechanically coupled to said angled plate.
